(19) United States
(12) Patent Application Publication
(10) Pub. No.: US 2008/0135649 A1
(43) Pub. Date: Jun. 12, 2008

(54) Aerosol Nozzle Adaptor

(75) Inventor: David William Smyth, Budina Beach (AU)

Correspondence Address: Martin P. Hoffman;Hoffman, Wasson & Gitler, P.C., 2461 South Clark Street, Suite 522, Arlington, VA, 22202, US

(73) Assignee: ACA PRODUCTS PTY LTD, Queensland (AU)

(21) Appl. No.: 10/550,061

(22) PCT Filed: Mar. 25, 2004
(86) PCT No.: PCT/AU2004/000367

§ 371 Date: Feb. 8, 2008

(30) Foreign Application Priority Data
Mar. 27, 2003 (AU) 2003901401

(51) Int. Cl. B05B 15/08; B65D 83/00

(52) U.S. Cl. 239/588; 222/402.1

(57) ABSTRACT

An aerosol nozzle adaptor (10) for a nozzle head (11), the adaptor (10) comprising a mounting attachment (13) capable of maintaining a supporting engagement with an aerosol container (12) and a tube (14) having an internal passage and first (15) and second (16) tube ends, said first tube end (15) being adapted to engage the nozzle head (11) so as to provide a continuous fluid passage therewith and said second tube end (16) being adapted to direct the fluid upon the expulsion therefrom.

### FIELD OF THE INVENTION

The present invention relates to aerosol nozzle adaptors and in particular to an apparatus allowing the injection of material contained in an aerosol container to be applied accurately and easily into relatively inaccessible places.

### BACKGROUND ART

Many fluids come in pressurized containers and are designed to be applied by means of a spray nozzle affixed to a valve in the top of the container. Typically, fluid is released by depressing the spray nozzle head, which causes the valve in the top of the container to open, allowing fluid to be released through a fluid passage in the spray nozzle. The spray nozzle head itself can be adapted to release the fluid in a variety of configurations ranging from a fine, dispersed mist to a thin stream. In addition, it is common in some applications to provide a small diameter tube that can be inserted into frictional engagement with the exit opening of the nozzle head. When so mounted, the small diameter tube provides an extension to the nozzle head and allows the fluid stream to be controlled at the exit opening of the tube, rather than at the exit opening of the nozzle head. This allows application of the pressurized fluid into areas where the nozzle head would not provide thorough or accurate application of the fluid.

Furthermore, when the tube is used with the pressurized fluid container, passage of the fluid itself through the tube can cause the tube to disengage from the nozzle head. Alternatively, the tube can be dislodged by inadvertent contact of the tube with other objects. Because the tube is typically used in crowded application areas that are difficult to reach, disengagement of the tube from the nozzle head during use can result in loss of the tube when the dislodged tube falls into an inaccessible area. Hence, it is desired to provide an application tube that is firmly connected to the pressurized container during both spray applications and storage.

Because the conventional extension tubes comprise short, rigid tubes, they add little advantage in applying pressurized fluid to hard-to-reach areas. Hence it is further desired to provide a device that will allow application of pressurized fluid to areas that cannot be reached with a conventional straight tube.

There are several instances in which such a flexible remote applicator for pressurized fluid is desired. One is the aviation industry, in which delicate mechanical and electromechanical parts must be frequently checked and cleaned or lubricated. In addition, it is common in the aviation industry to apply corrosion inhibiting compounds (CIC's) to exposed surfaces. The materials from which airplanes and their component parts are made are typically subject to corrosion and must be protected by maintenance of a corrosion inhibiting layer on their surfaces. CIC's are applied during manufacture of the parts, using large expensive bulk applicators. Many CIC's do not last the lifetime of the part to which they are applied, however, and must be reapplied. Because it is not practical for post-manufacture maintenance facilities to operate such large bulk applicators, after manufacturing CIC's are typically applied from small pressurized containers such as aerosol cans. Thus, it is often desired to provide an improved device that allows CIC's to be applied from these cans in an easier and more accurate manner.

The automotive industry is a second area in which it is often desired to apply pressurized fluid remotely and accurately. Pressurized containers can be used in the automotive industry to apply lubricants, degreasers, cleaning fluids, rust inhibitors or the like. A particularly troublesome area is the application of corrosion inhibiting fluids to the interior of enclosed metal panels. In addition to accessing hard-to-reach spots, it may be desired to apply pressurized fluid to an area of an automobile engine while the engine is hot or running. As automobiles grow more complex, the necessity for accurate remote application increases.

A third industry that could benefit from a device that allows accurate remote application of pressurized fluid is the pest control industry, in which toxic chemicals are frequently used. It is desirable to minimize excess spray of such chemicals, while at the same time ensuring penetration of the chemicals into remote or small areas. Other areas that could benefit from remote accurate fluid application include guns, machinery, and air conditioning equipment.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to an aerosol nozzle adaptor, which may at least partially overcome at least one of the abovementioned disadvantages or provide the consumer with a useful or commercial choice.

In one form, the invention resides in an aerosol nozzle adaptor for a nozzle head, the adaptor comprising a mounting attachment capable of maintaining a supporting engagement with an aerosol container and a tube member having an internal passage and first and second tube ends, said first tube end being adapted to engage the nozzle head so as to provide a continuous fluid passage therewith when connected and said second tube end being adapted to direct the fluid upon expulsion therefrom.

The aerosol nozzle adaptor of the invention will generally be associated with an aerosol can containing some type of fluid with a useful purpose. The aerosol nozzle adaptor will suitably be removably attachable relative to the aerosol can and nozzle head. In this way, the adaptor may be used with a variety of cans and can be re-used.

The mounting attachment may suitably facilitate the removable attachment of the adaptor in relation to the aerosol can and particularly the nozzle head. The mounting attachment will generally be a clip or a ring.

Where a clip mounting is provided, the clip may for example, be a pair of jaws biased into a closed condition to grip the can or nozzle head.

Aerosol cans are generally manufactured with a cylindrical body portion and an upper and lower hemispherically or torispherically shaped, end members which are press fitted to the body portion. The upper end member has a fill opening which, after filling, is capped with a press-fitted cap having a dispensing valve therein. The press-fitting attachment of the portions forms a shoulder portion.

Suitably, the mounting attachment accomplishes the attachment of the nozzle adaptor relative to the can and/or nozzle head and also facilitates the supporting engagement therebetween by engagement with a shoulder portion.

The mounting attachment may be slightly deformable/resilient to securely fasten the nozzle adaptor relative to the can and/or nozzle head.

Newer cans have different nozzle heads and as such may require that the mounting attachment engage with the shoulder portion formed between the upper cap and the body portion of the can.

According to a particularly preferred embodiment, the mounting attachment is a planar ring member adapted to fit over a shoulder portion and securely attach the nozzle adaptor relative to the can and/or nozzle head.

The mounting attachment may further comprise a tube attachment member. This member will suitably extend substantially perpendicularly from the ring or clip. The tube attachment member will typically be provided with a means for releasably attaching the tube thereto. In a preferred form, this means may be as simple as a hole or opening through which the tube may be inserted. Suitably, the tube and opening may fit together with an interference type fit so that the attachment of the tube is not overly complex or expensive. The outer diameter of the tube may be slightly larger than the internal diameter of the opening.

The tube is suitably manufactured from flexible or resilient plastics material.

The aerosol nozzle adaptor may further comprise a locking means to lock the mounting attachment in position relative to the can or nozzle head. The locking means will generally be associated with the mounting attachment itself.

The locking means will preferably be movable between a locked condition wherein the locking means is adapted to prevent removal or displacement of the mounting attachment and an unlocked condition in which the mounting attachment is removable from the can and/or nozzle head.

In a particularly preferred form, the locking means may be a clip down locking tab. The locking tab may be elongate and substantially planar. The tab may be pivotably or rotatably associated with the mounting attachment and more preferably, with an upper portion of the tube attachment member.

The tab may be provided with a nozzle head engaging portion. The engaging portion may be a flange depending from an underside of the locking tab which may be shaped to receive and engage the nozzle head or part of the aerosol can to which it is attached.

In its preferred form, the locking tab may be used or may act as an extension to the nozzle head and manipulating the locking tab may actuate the nozzle head, allowing fluid to flow from the aerosol can. The locking means may be provided with a portion to engage and be secured by a correspondingly shaped portion on or associated with the tube attachment member to prevent the locking tab moving between the locking and unlocking condition except according to the desires of a user.

The tube member may preferably be flexible or rigid or it may be a combination of flexible and rigid portions. The first end of the tube member is generally sized to engage with the nozzle head. In particular, nozzle heads are generally provided with an outlet with a circular recess provided about the outlet. The tube may preferably engage with the circular recess.

The tube may be slightly resilient in order to attach and securely grip the nozzle head. Suitably, the tube may be inserted into and/or through the opening in the tube attachment member. The tube may be of any suitable length but will generally be a maximum of about 1 meter. The tube may be shorter or longer depending upon its application.

The tube may be provided with marker means to enable a user to judge the distance to the second end of the tube. There may be a single marker means or a plurality of spaced marked means.

The tube will typically have a circular cross-section but may have other cross-sections depending upon a user's requirements.

The tube may be provided with a spray nozzle to be associated with the second end of the tube. The spray nozzle may be separate from but attachable to, the tube. The spray nozzle may comprise an insert portion allowing insertion of and/or retention of the spray nozzle into the tube. Preferably, the insert portion may have a differently shaped cross-section to the tube allowing fluid to flow past the insert portion.

The spray nozzle may also be provided with a free end portion. The free end portion may be provided with a deflecting surface, shaped to provide a specific flow pattern for the fluid being expelled from the tube. The deflecting surface may be substantially hemispherical or shaped to provide a 360° spray pattern substantially perpendicularly to the tube.

The free end of the spray nozzle will generally be spaced from the second end of the tube. This space may allow the fluid to exit the tube before being deflected by the deflection surface. The outer end of the free end may also suitably be shaped to provide lowered resistance as the tube is inserted. The outer end may be dome shaped or bulbous.

There will generally be an elongate connector portion in between the insert portion and the deflecting surface of the spray nozzle. The connector portion will typically be smaller in diameter than other portions of the spray nozzle.

The aerosol nozzle adaptor may be provided with a nozzle head actuating means, which according to a preferred embodiment may be the locking means, but it is to be anticipated that the actuating means may be a separately provided assembly or member.

### BRIEF DESCRIPTION OF THE DRAWINGS

A preferred embodiment of the invention will be described with reference to the following drawings, in which:

FIG. 1A is a perspective view of the aerosol nozzle adaptor according to an aspect of the present invention with the locking tab in the unlocked condition.

FIG. 1B is a perspective view of the aerosol nozzle adaptor according to an aspect of the present invention with the locking tab in the locked condition.

FIG. 2 is an exploded perspective view of the second end of the tube and the spray nozzle according to an aspect of the present invention.

FIG. 3 is a perspective view of the aerosol nozzle adaptor and tube in position on an aerosol can.

FIG. 4 is a schematic view of a method of use of the aerosol nozzle adaptor according to a preferred embodiment of the invention.

FIG. 5 is a schematic view of the spray pattern achieved by an aspect of the present invention.

### DETAILED DESCRIPTION OF THE PREFERRED EMBODIMENT

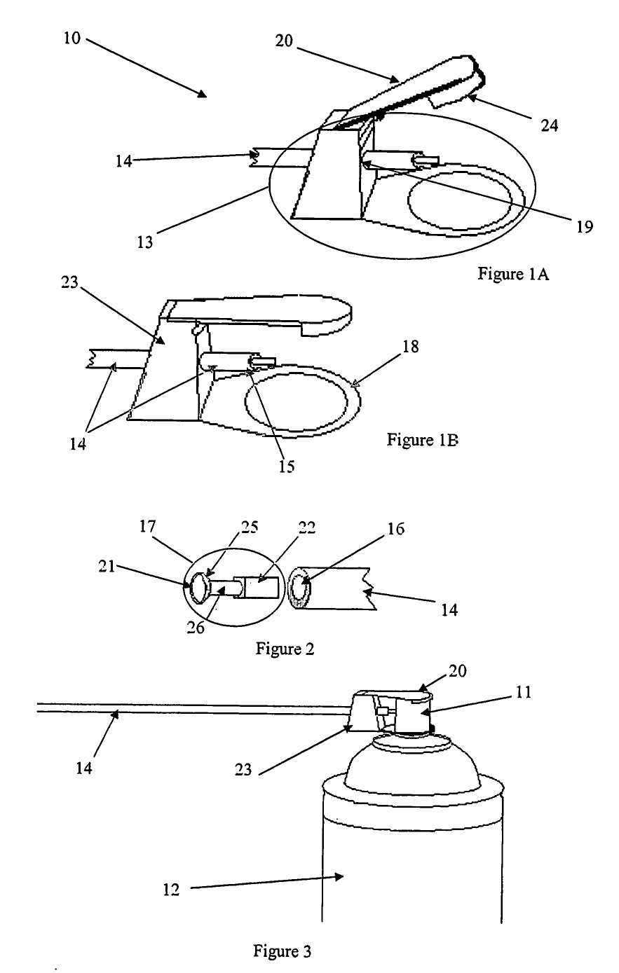

According to the present invention, an aerosol nozzle adaptor 10 is provided, a preferred embodiment of which is illustrated in FIGS. 1 to 5.

The aerosol nozzle adaptor 10 is adapted to fit a nozzle head 11 of an aerosol can 12. The adaptor 10 comprises a mounting attachment 13 capable of maintaining a supporting engagement with an aerosol can 12. The mounting attachment 13 is associated with a flexible tube 14 having an internal passage and first 15 and second 16 tube ends. The first tube end 15 is adapted to engage the nozzle head 11 so as to provide a continuous fluid passage therewith and the second tube end 16 is adapted to direct the fluid upon expulsion from the tube 14.

The adapter 10 and spray nozzle 17 is attached to the upper portion of the aerosol can 12 and relative to the nozzle head 11 by sliding the retaining ring 18 over the nozzle head 11 and inserting the tube 14 into the tube mounting hole 19. The adapter 10 is then secured relative to the nozzle head 11 with the clip-down locking tab 20 as shown in FIGS. 1A and 1B. The adapter 10 will not release from the spray can 12 during use, unless or until the locking tab 20 is released.

The locking tab 20 is provided with a nozzle head engaging flange 24. The engaging flange 24 depends from an underside of the locking tab 20 and is shaped to receive and engage the nozzle head 11 or part of the aerosol can 12 to which it is attached.

There is a tube attachment portion 23 extending substantially perpendicularly to the retaining ring 18. The tube attachment portion 23 provides the necessary attachment to allow the tube 14 to be spaced above the retaining ring 18.

The tube 14 is a flexible nylon tube, which is small enough to access panels through screw holes, drain holes or any access holes in the article in relation to which the aerosol is to be used. The flexible nylon tube 14 according to the embodiment illustrated is only ⅛″ or 3.2 mm in diameter which makes it small enough to be inserted in small holes in car body panels. The flexible nylon tube 14 can also access areas such as window frames, sill panels, classic rails, door pillars, wheel arches and roof gutters. Any difficult to reach portion should be reachable by manipulating the tube 14. The nylon tube 14 is flexible and this will allow it to follow curves in the limited access portions.

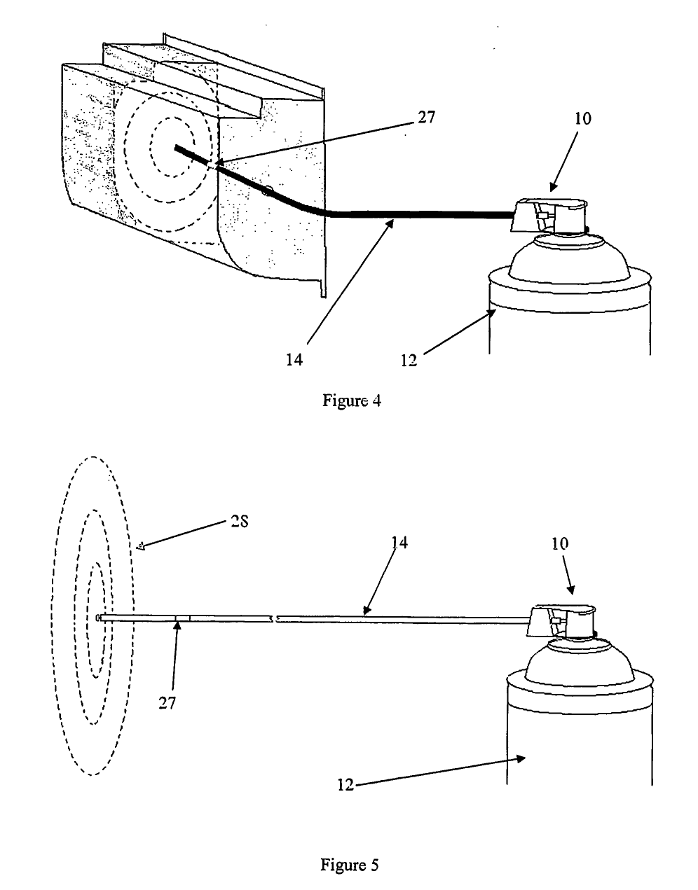

The spray nozzle 17 as seen in FIG. 3 is designed to allow the fluid expelled from the can 12 via the nozzle 17 to accumulate near the second end 16 of the tube 14 and emerge through the small gap between the second end 16 of the nylon tube 14 and the spray nozzle 17. The shape and configuration of the spray nozzle 17, particularly the deflecting surface 25 directs the expelled fluid as a 360° spray circle extending substantially perpendicularly to the tube 14 as illustrated in FIG. 5. The deflecting surface 25 is spaced a short distance from the insert portion 21 by a connecting portion 26.

According to a preferred method of operation, the user inserts the nylon tube 14 through an access point and feeds the tube 14 into the panel as far the tube will reach, or as far as required.

The simple maneuver of applying downward force to the aerosol can nozzle head 11 starts the flow of fluid and the spray nozzle 17 positioned at the end of the flexible nylon tube 14 will direct the inhibitor liquid in a 360° spray pattern 28 at right angles to the tube 14. By drawing the flexible nylon tube 14 back out of the access hole, the user can apply a coat of fluid to all interior surfaces of the panel being treated as illustrated in FIG. 4.

A coloured band 27 around the flexible nylon tube 14, located approximately 60 cm from the second end of the tube 14 is an indicator to the operator to stop the spray application before the spray nozzle 17 emerges from the panel being treated.

The can adaptor 10 is made from a flexible plastic or nylon. The spray nozzle 17 is made from a ridged plastic.

The spray nozzle 17 is provided with an insert portion 21 shaped to allow fluid expelled into the tube 14 to flow past the insert portion 21 when inserted into the nylon tube 14. When the procedure is activated, the fluid expelled into the tube 14 accumulates near the end of the tube 14 and emerges through a small gap between the nylon tube 14 and the spray nozzle 17 as a 360° spray at a right angle to the tube 14. The free end 22 of the nozzle is rounded or domed to allow the tube 14 to be pushed around comers and into normally inaccessible panels.

The length of the flexible nylon tube 14 can vary, but for convenience and easy operation, the length will be about 1 metre.

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. An aerosol nozzle adaptor for a nozzle head, the adaptor comprising a tube member having an internal passage and first and second tube ends, said first tube end being adapted to engage an aerosol container nozzle so as to provide a continuous fuid passage therewith when connected and said second tube end being adapted to direct the fluid upon expulsion therefrom and a mounting attachment capable of maintaining the tube in supporting engagement with an aerosol container nozzle, wherein a spray nozzle is provided to be associated with the second end of the tube, the spray nozzle comprising an insert portion allowing insertion and retention of the spray nozzle into the tube, and a free end portion, the free end portion having a deflecting surface, shaped to provide a specific flow pattern for the fluid being expelled from the tube.

2. The aerosol nozzle adaptor of claim 1 wherein the mounting attachment facilitates the removable attachment of the adaptor in relation to an aerosol can and particularly the nozzle head.

3. The aerosol nozzle adaptor of claim 2 wherein the mounting attachment comprises a clip or a ring which engages an aerosol container nozzle of the aerosol can.

4. The aerosol nozzle adaptor of claim 3 wherein the mounting attachment further comprises a tube attachment member extending substantially perpendicularly from the ring or clip, the tube attachment member provided with a means for releasably attaching the tube thereto.

5. The aerosol nozzle adaptor of claim 1 wherein the aerosol nozzle adaptor further comprises a locking means to lock the mounting attachment in position relative to an aerosol can or nozzle head.

6. The aerosol nozzle adaptor of claim 1 wherein the locking means is movable between a locked condition wherein the locking means is adapted to prevent removal or displacement of the mounting attachment and an unlocked condition in which the mounting attachment is removable from an aerosol can and/or nozzle head.

7. The aerosol nozzle adaptor of claim 6 wherein the locking means is a clip down substantially planar locking tab, pivotably associated with the mounting attachment, the tab provided with a nozzle head engaging portion.

8. The aerosol nozzle adaptor of claim 6 wherein the tube is provided with marker means to enable a user to judge the distance to the second end of the tube.

9. (canceled)

10. The aerosol nozzle adaptor of claim 1 wherein the free end of the spray nozzle is spaced from the second end of the tube to allow the fluid to exit the tube before being deflected by the deflection surface.
